(19) United States
(12) Patent Application Publication
(10) Pub. No.: US 2008/0257128 A1
(43) Pub. Date: Oct. 23, 2008

(54) Mandoline with adjustable cutting depth

(75) Inventors: Gina Reimann, Brooklyn, NY (US); Eben Sargent, Seattle, WA (US); Jonathan Cedar, Brooklyn, NY (US); Timothy Jude Kennedy, Staten Island, NY (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 11/787,592

(22) Filed: Apr. 17, 2007

(51) Int. Cl. B26D 7/26

(52) U.S. Cl. 83/699.61

(57) ABSTRACT

A food slicer is disclosed having a frame with a track thereon, an adjustable pre-cut surface attached to the frame, a post-cut surface attached to the frame following the pre-cut surface, a blade disposed on the frame between the two surfaces, and a sliding mechanism movably secured within the track of the frame and engaged to support the adjustable pre-cut surface across the entire width of the surface, wherein sliding movement of the mechanism within the track raises and lowers the pre-cut surface relative to the blade. The track of the food slicer may include a plurality of detents for indexed movement of the sliding mechanism and the pre-cut surface may be made of a translucent or even transparent material to permit accurate placement of a catch bowl for the sliced food items.

### TECHNICAL FIELD OF THE INVENTION

The present device relates to a food slicer, a.k.a., a mandolin. Particularly, the present device relates to slicer having an adjustable cutting depth.

### BACKGROUND OF THE INVENTION

Mandolins, or food slicers as they are commonly called, are well-known in the art. Adjustability of the cutting depth is a feature many manufactures have experimented with in order to provide a more useful product. The adjustable cutting feature should provide simple manufacture and operation, easy clean-up and maintenance, reproducible cutting depths, a sturdy cutting mechanism, and quick and easy adjustment between cutting depths.

Prior art devices have typically used one of three different mechanisms for adjusting the cutting surface: cam-type adjusters, cutting inserts, and screw adjusters. Each of these three mechanisms provide certain advantages and disadvantages. None achieve all of the desired advantages of an adjustable cutting feature described above.

The cam-type adjusters are comprised of a mechanism which raises and lowers either the pre-cut surface of the slicer or the cutting blade itself. Most cam-type mechanisms include a knob or slider which engages a cam device to change the cutting depth of the slicer. While almost infinitely adjustable between two end points, these types of adjustment mechanisms can be relatively complex, hard to keep clean, and difficult to accurately reproduce a previous cutting depth without an indexing feature. Inadequate support of the pre-cut surface is also a disadvantage of the cam-type adjusters. The pre-cut surface might only be supported at a few points, and on occasions just a single point.

Devices which utilize cutting inserts to change cutting depths provide limited cutting depths, maybe two or three varied inserts. On the other hand, cutting depths are easily reproducible. Complexity of manufacture and ease and speed of adjustment are disadvantages of these types of devices. The inserts must be capable of being interchanged with minimal tolerances to provide a stable cutting area, and locking features may hinder the ability to quickly unplug and plug in inserts.

Screw-type adjusters are perhaps the least complex of the three adjustment types. However, the reproducibility of cutting depths, absent a separate indexing feature, is low and adjustments may require inverting the slicer to allow access to the adjusting screws. Similar to the cam-type adjusters, the screw mechanisms provide limited support to the pre-cut surface and are prone to deteriorating efficiency over time due to inadequate cleaning.

The present food slicer provides an adjustable cutting depth that solves each of these problems associated with the prior art, while avoiding many of the common disadvantages of such devices. The disclosed device affords other structural, manufacture and operating efficiencies not seen in prior art devices, as well.

### SUMMARY OF THE INVENTION

Generally speaking, a food slicer is disclosed comprising a frame having a track thereon, an adjustable pre-cut surface attached to the frame, a post-cut surface attached to the frame following the pre-cut surface, a blade disposed on the frame between the two surfaces, and a sliding mechanism movably secured within the track of the frame and engaged to support the adjustable pre-cut surface across the entire width of the surface, wherein sliding movement of the mechanism within the track raises and lowers the pre-cut surface relative to the blade.

In an embodiment of the present food slicer the track comprises a plurality of detents for indexed movement of the sliding mechanism and the pre-cut surface is translucent or even transparent to permit accurate placement of a catch bowl for the sliced food items.

In another embodiment of the present food slicer, the device comprises a frame, a translucent, adjustable pre-cut surface attached to the frame, a post-cut surface attached to the frame following the pre-cut surface, a blade disposed on the frame between the two surfaces, and a support mechanism movably secured to the frame and engaged to support the pre-cut surface across the entire width of the surface, wherein movement of the mechanism raises and lowers the pre-cut surface relative to the blade.

In still another embodiment of the present food slicer, the device is configured for creating Julienne slices and comprises a frame having a track thereon, an adjustable pre-cut surface attached to the frame, a post-cut surface attached to the frame following the pre-cut surface, a plurality of first blades disposed on the pre-cut surface, a second blade disposed on the frame between the two surfaces perpendicular to the plurality of first blades, and a sliding mechanism movably secured within the track of the frame and engaged to support the adjustable pre-cut surface across the entire width of the surface, wherein sliding movement of the mechanism within the track raises and lowers the pre-cut surface relative to the first blade.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the present handheld mandolin;

FIG. 2 is a top view of the embodiment illustrated in FIG. 1;

FIG. 3 is a bottom view of the embodiment illustrated in FIG. 1;

FIG. 4 is a partial cross-section of an embodiment of the present handheld mandolin illustrating a completely raised pre-cut surface;

FIG. 5 is similar to the partial cross-section of FIG. 4, illustrating a the lowering of the pre-cut surface for thicker slices;

FIG. 6 is a partial exploded view of an embodiment of the present handheld mandolin;

FIG. 7 is a perspective view of an embodiment of the present handheld mandolin including a food holder;

FIG. 8 is a perspective view of another embodiment of the present handheld mandolin illustrating a transparent pre-cut surface; and

FIG. 9 is a perspective view of another embodiment of the present handheld mandolin suitable for Julienne slicing.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

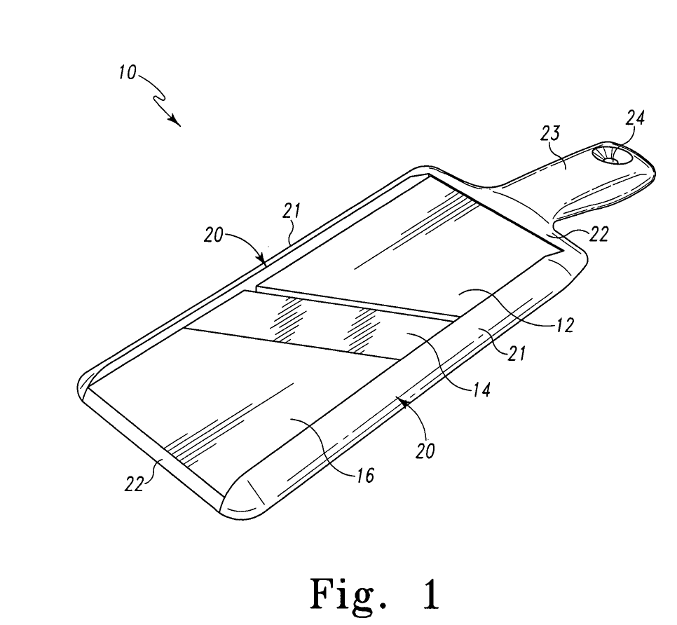

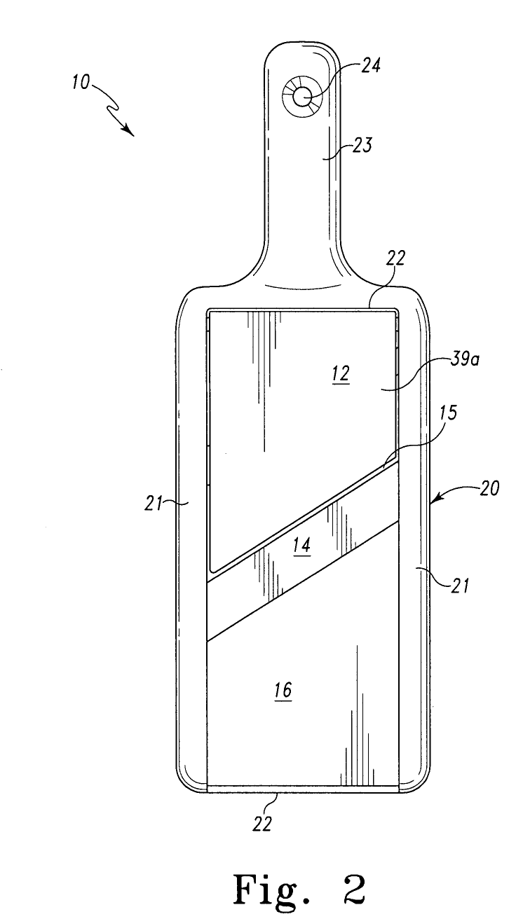

Referring to FIGS. 1-9, there is illustrated embodiments of a food slicer, generally designated by the numeral 10. Generally speaking, the slicer or mandolin 10 has an adjustable pre-cut surface 12, a sliding support or adjustment mechanism, a blade section 14, a post-cutting surface 16, a frame 20 substantially surrounding the previous components, and a handle 23 attached to the frame 20.

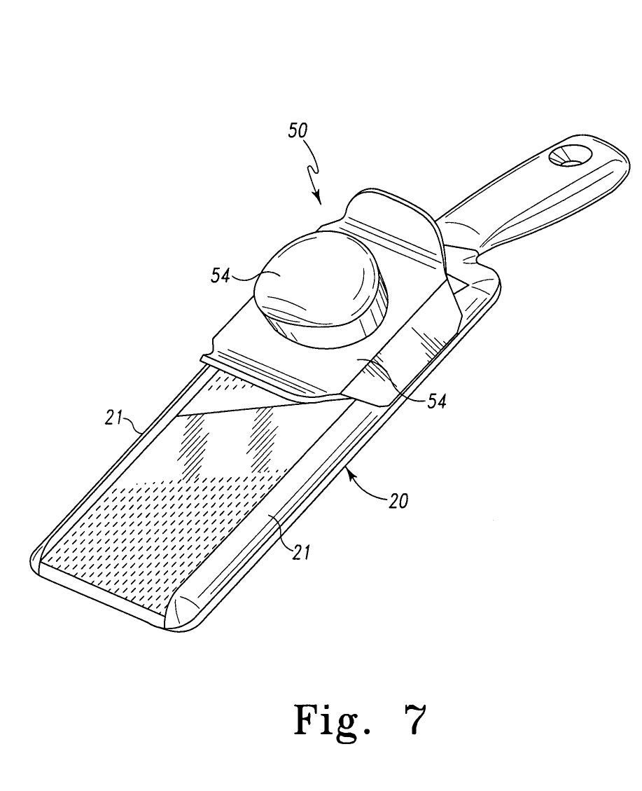

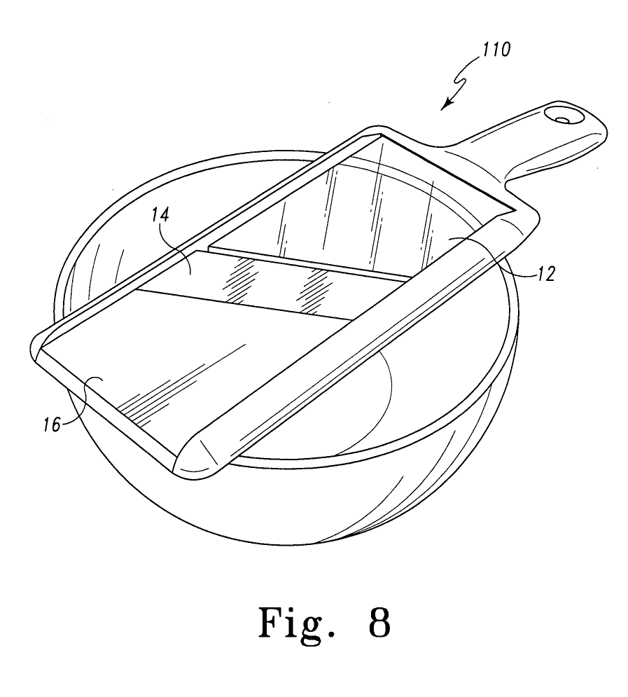

As shown in FIGS. 1-3, the frame 20 has two side members 21 and two end members 22. The overall configuration of the frame 20 is preferably rectangular. A handle 23 is preferably centered and secured to one of the end members 22 of the frame 20. As shown best in FIG. 7, the handle 23 is attached at a slight angle relative to the frame. The handle angle provides a more ergonomic positioning for the user's hand when using the slicer 10. A hole 24 in the handle 23 provides means by which to hang the slicer 10, if desired. The handle 23 may be integral to the frame, with both being formed, most preferably, of a rigid plastic material. Alternative materials would include other suitable plastics, wood, metal, composites and combinations of such materials. For comfort, the handle 23 may be covered in a soft foam-like material or, for example, SANTOPRENE®.

The side members 21 of the frame 20 extend above and below the pre-cut surface 12 and post-cutting surface 16, while the end members 22 are preferably only below the surfaces. This configuration provides a channel-like top-side of the slicer 10 facilitating the slicing motion of the user.

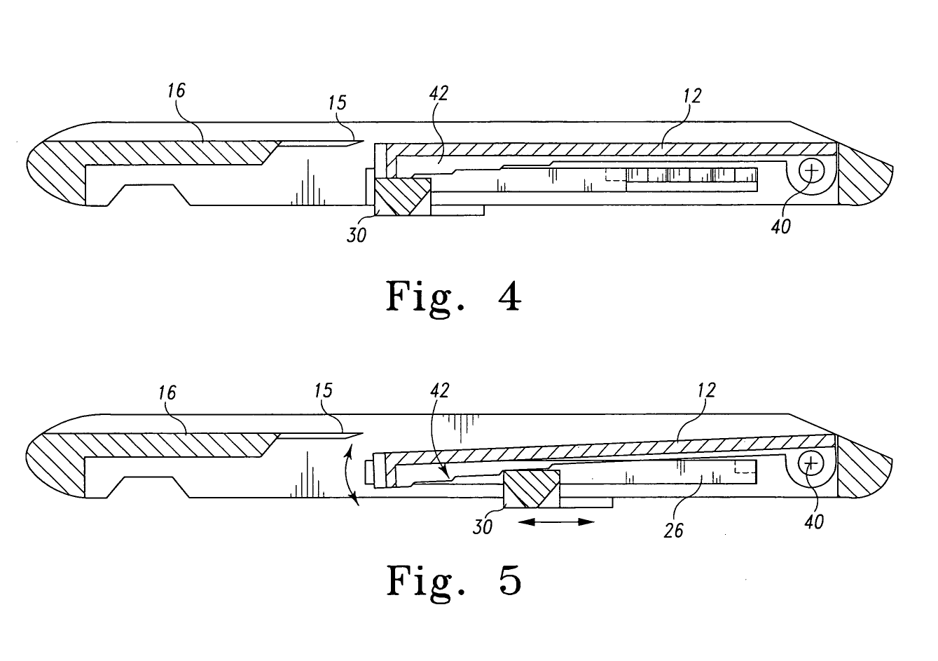

A track 26 is shown in FIGS. 4 and 5 within the frame 20 on the underside of slicer 10. Within the track 26, below the pre-cut surface 12, is secured the sliding support or adjustment mechanism 30. The sliding mechanism 30 is preferably a rigid bar which extends the entire width of the pre-cut surface 12 being secured within the track 26 on each side member 21. The sliding mechanism 30 is secured within the track 26 at an angle, as will be explained below. The purpose of the sliding mechanism 30 is to provide both support and vertical adjustability to the pre-cut surface 12. Being secured with the track 26, allows the sliding mechanism 30 to be moved in the direction of the arrows shown in FIG. 5. The track surface may include small teeth to secure the sliding mechanism at a given point, preventing inadvertent movement and cutting depth changes.

A finger switch 32 is preferably attached to one end of the sliding mechanism 30 and is accessible along an outer surface of a side member 21. The finger switch 32 provides the user with a simple device by which to manipulate the sliding mechanism 30 within the track 26 without having to reach the underside of slicer 10. The switch 32 preferably includes a textured surface to facilitate tactile recognition and slip resistance to the user.

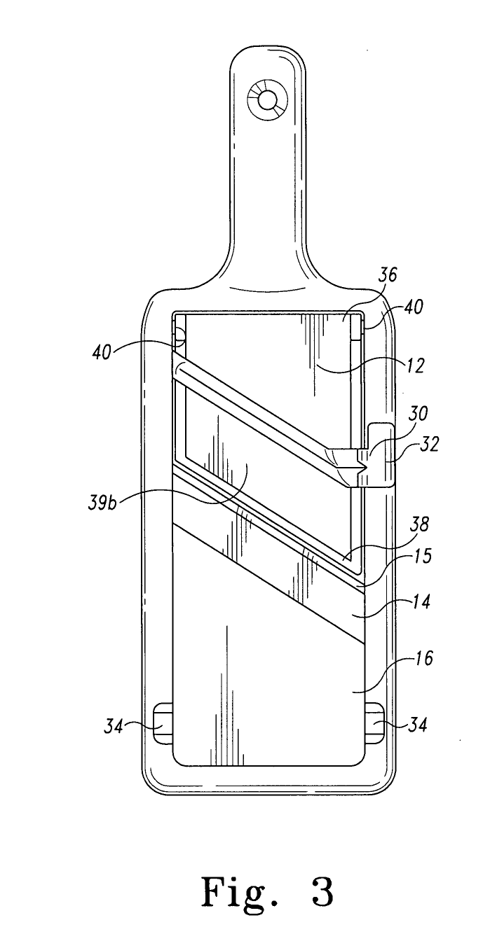

Returning to FIG. 3, a pair of container notches 34 are shown in the underside of the side members 21 of the frame 20. These notches 34 are configured to engage the rim of a container positioned below the slicer 10 to catch the sliced food items. To prevent slipping at the point of contact with the container, a soft, slip-resistant material such as SANTOPRENE® may be used to cover this portion of the side members 21. Likewise, the end member 22 may also be covered with such material to reduce slipping of the slicer 10 placed onto, for example, a kitchen countertop.

The pre-cut surface 12 has a tetragonal shape, preferably a trapezoidal shape, with a hinged first end 36 and a free second end 38, and upper and lower surfaces, 39a and 39b, respectively. The first end 36 is secured to the frame 20 by hinge elements 40. Alternatively, a hinge pin (not shown) or similar device may be used to secure the first end 36 to the frame 20. The free second end 38 is positioned adjacent the blade section 14, meeting along a line angled relative to the side members 21 of frame 20. The angle of the meeting line facilitates slicing by allowing the food item (not shown) to effectively be moved in a direction of travel along blade 15 (i.e., slicing as opposed to chopping).

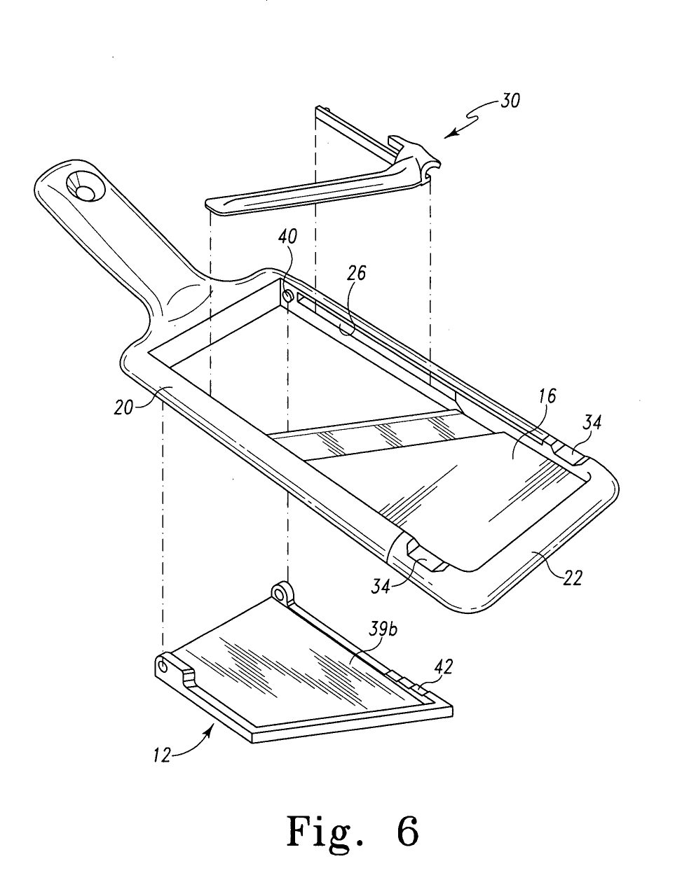

The upper surface 39a of the pre-cut surface 12 may be ribbed or otherwise textured to facilitate tracking of food items in a straight-line toward the blade section 14. The lower surface 39b comprises a plurality of ramp sections 42 in tiered-arrangements. In the present embodiment, the ramp sections 42 increase in height as they get closer to the blade section 14. While a single set of ramp sections 42 are shown in FIG. 6, it is understood that in other embodiments such sections may extend the width of the pre-cut surface 12 or may be more numerous and spaced across the same width. The greater surface area provided by the ramp sections 42, the greater support provided to the pre-cut surface 12, as will be explained below.

The pre-cut surface 12 is preferably made from a rigid or semi-rigid thermoplastic material. However, alternative materials may be suitable for certain application. In one embodiment of the present slicer 10 shown in FIG. 8, the pre-cut surface 12 is manufactured from a translucent material, which may be transparent. The use of translucent material for the pre-cut surface 12 allows the user to more readily align a bowl or the like below the slicer 10 to catch sliced food items as illustrated in FIG. 8. This feature may work in conjunction with the container notches 34 discussed above, also for proper positioning of a container.

Referring now to the blade section 14 shown in FIGS. 4 and 5, the adjustable cutting feature can be more readily understood. Preferably, the blade section 14 is secured at an angle (as described above) in a fixed position between the two frame side members 21. The blade section 14 comprises a cutting blade 15 extending the width of the pre-cut surface 12. The blade 15 is secured within the blade section such that the cutting edge of the blade 15 faces the pre-cut surface 12. Unlike the pre-cut surface 12, the blade section upper surface 39a is not textured to guide food items. Such texturing can sometimes interfere with the slicing operation. Further, except for the blade 15—which is preferably a stainless steel or other suitable metal—the blade section 14 is preferably manufactured of a material similar or identical to the material used for the pre-cut surface 12.

The post-cutting surface 16 is shown in FIG. 1. The post-cutting surface 16 acts as a continuation of the pre-cut surface 12. Accordingly, it is preferably similarly textured to guide food items being sliced. The post-cutting surface 16 is secured in a fixed position between the two frame side members 21. As with the pre-cut surface 12, the post-cutting surface 16 may be translucent, even transparent, to facilitate positioning of the slicer 10 over a container.

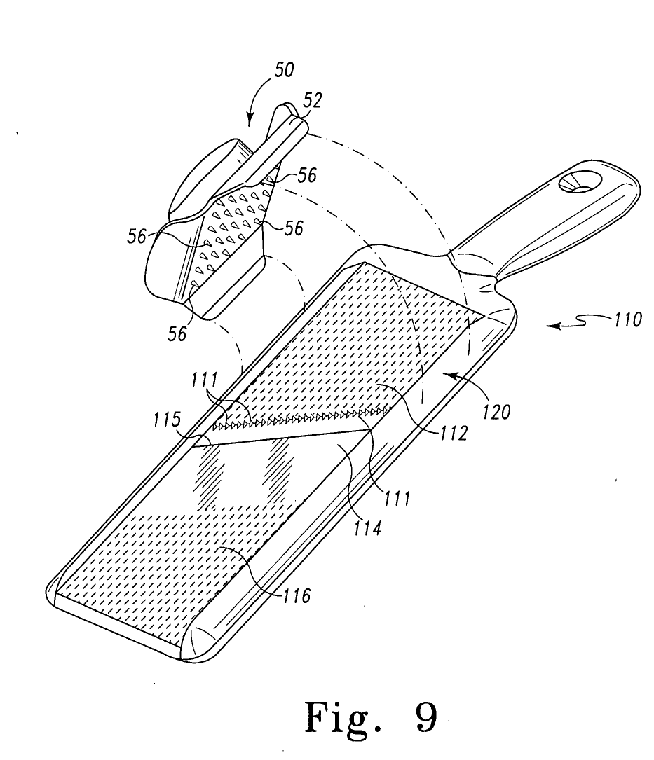

With reference to FIG. 7, as is known in the art, a food holder 50 may be employed to protect the user's fingers from accidental cuts on blade 15. The holder 50 is preferably comprised of a grip 54, a protective shield 52, and a holding means 55 (FIG. 9). The holding means 55 is typically comprised of a plurality of teeth 56 which pass through the shield 52 and are set into a fixed position. Alternative holding means (not shown) may include substantially longer prongs and a spring or other biasing means which moves the shield 52 against skewered food items over the substantial length of the prongs to automatically advance food items on the prongs as they are being sliced.

FIG. 9 shows a Julienne slicing mandolin 110. FIG. 9 also illustrates how the holder 50 aligns with the frame 120 to guide slicing of food items on mandolin 110. As can be seen, the mandolin 110 of FIG. 9 is configured with additional blades 111, looking like teeth projecting perpendicularly from pre-cut surface 112. These additional blades 111 are used to score a food item such that the blade 115 of blade section 114 will cut the item to create strips rather than whole slices. This process is known in the industry as Julienne slicing. The longer the blades 111, the deeper the cut on the food item and the thicker the resulting Julienne strips. Of course, while the pre-cut surface 112 may be adjusted to create thicker or thinner Julienne slices, the additional blades 111 are preferably set in a fixed position. For dicing, the food item can be double or cross-scored by the additional blades 111—i.e., one pass across blades 111 without slicing on blade 115 creates strips, then a second pass across blades 111 about 450 offset from the first pass creates a cross-hatched surface—before slicing on blade 115 to create cubes.

In use, the slicer 10 is positioned by the user with the handle 23 in one hand and the opposite end is either engaged with the rim of a container or rested on a relatively flat surface. If the pre-cut surface 12 or post-cutting surface 16 is translucent, the container intended to catch the sliced food items can be easily positioned beneath the blade section 14. The slicer 10 can be held comfortably at roughly a 45° angle (to a horizontal surface).

Before slicing, the thickness of the desired sliced food items should be determined, through “trial and error” if necessary, and the sliding mechanism 30 can be set accordingly. By moving the sliding mechanism 30 toward the handle 23, the slice thickness increases. This is because, in the present embodiment, the ramp sections 42 of the pre-cut surface decrease in height toward the handle, as shown in FIG. 4, thereby creating a lower support and a greater gap between the pre-cut surface 12 and the blade 15.

Conversely, movement of the sliding mechanism 30 away from the handle 23 will raise the pre-cut surface 12 relative to the blade 15 due to the higher ramp sections 42. As a safety feature, the pre-cut surface 12 may be above the blade at its highest point, thereby eliminating the potential for accidental cutting during non-use.

Once the desired cutting thickness is set, the food item may be placed into the food holder 50, if used. By pushing the prongs of the holder 50 into the food item, the shield 52 is pushed to a retracted position. The food item can then be placed onto the pre-cut surface 12 and, in a reciprocating motion, moved toward the post-cutting surface 16 and back again until the amount of sliced food items are achieved or until the food item is too small to continue slicing. The textured form of the pre-cut surface 12 and post-cutting surface 16 help guide and track the cutting and return motion. As the food item is sliced, the spring or other biasing member advances the shield 52 and in turn the food item forward on the prongs. Naturally, with the proper hand protection, a user may choose to disregard the use of the holder 50 for some uses. An abundance of caution should be exercised in such cases.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A food slicer comprising:
a frame having a track thereon;
an adjustable pre-cut surface attached to the frame;
a post-cut surface attached to the frame following the pre-cut surface;
a blade disposed on the frame between the two surfaces; and
a sliding mechanism movably secured within the track of the frame and engaged to support the adjustable pre-cut surface across the entire width of the surface, wherein sliding movement of the mechanism within the track raises and lowers the pre-cut surface relative to the blade.

2. The food slicer of claim 1, wherein the track comprises a plurality of detents for indexed movement of the sliding mechanism.

3. The food slicer of claim 1, wherein the pre-cut surface is translucent.

4. The food slicer of claim 1, wherein the pre-cut surface is transparent.

5. The food slicer of claim 1, wherein the blade is disposed at an angle and the sliding mechanism is disposed in the track at an angle approximately equivalent to the angle of the blade.

6. The food slicer of claim 5, wherein the frame comprises a rail along each of the two opposing side edges of the pre-cut and post-cut surfaces, and wherein the sliding mechanism is secured within the two rails.

7. The food slicer of claim 1, wherein the pre-cut surface comprises a ramp on an undersurface which rests on the sliding mechanism.

8. The food slicer of claim 6, wherein the sliding mechanism travels along the ramp to change the pre-cut surface relative to the blade.

9. The food slicer of claim 1, further comprising a handheld food holder configured to engage the frame and travel above the surfaces and blades in a reciprocating motion.

10. A food slicer comprising:
a frame;
a translucent, adjustable pre-cut surface attached to the frame;
a post-cut surface attached to the frame following the pre-cut surface;
a blade disposed on the frame between the two surfaces; and
a support mechanism movably secured to the frame and engaged to support the pre-cut surface across the entire width of the surface, wherein movement of the mechanism raises and lowers the pre-cut surface relative to the blade.

11. The food slicer of claim 10, wherein the support mechanism comprises a slidable bar.

12. The food slicer of claim 11, wherein the support mechanism moves between a plurality of detents for indexed cutting depths.

13. The food slicer of claim 10, wherein the translucent pre-cut surface is transparent.

14. The food slicer of claim 10, wherein the blade is disposed on an angle and the support mechanism is disposed in the track at an angle approximately equivalent to the angle of the blade.

15. The food slicer of claim 10, wherein the frame comprises a rail along each of the two opposing side edges of the pre-cut and post-cut surfaces, and wherein the support mechanism is secured within the two rails.

16. The food slicer of claim 11, wherein the pre-cut surface comprises a ramp on an undersurface which rests on the sliding bar.

17. The food slicer of claim 16, wherein the sliding bar travels along the ramp to change the pre-cut surface relative to the blade.

18. The food slicer of claim 10, further comprising a handheld food holder configured to engage the frame and travel above the surfaces and blades in a reciprocating motion.

19. A food slicer for creating Julienne slices comprising:
a frame having a track thereon;
an adjustable pre-cut surface attached to the frame;
a post-cut surface attached to the frame following the pre-cut surface;
a plurality of first blades disposed on the pre-cut surface;
a second blade disposed on the frame between the two surfaces perpendicular to the plurality of first blades; and
a sliding mechanism movably secured within the track of the frame and engaged to support the adjustable pre-cut surface across the entire width of the surface, wherein sliding movement of the mechanism within the track raises and lowers the pre-cut surface relative to the first blade.
